(19) United States
(12) Patent Application Publication
(10) Pub. No.: US 2024/0330398 A1
(43) Pub. Date: Oct. 3, 2024

(54) OBJECTIVE-DRIVEN AUTOMATED SOURCING INTELLIGENCE SYSTEMS AND METHODS

(71) Applicant: Kinaxis Inc., Ottawa (CA)

(72) Inventors: Sriprasadh RAGHUNATHAN, Ottawa (CA); Jose MORAGUEZ PINOL, Kanata (CA); Prabhakar REGMI, Stittsville (CA); Harjot SINGH DHINDSA, Ottawa (CA); Alvaro FERNANDEZ GONZALEZ, Ottawa (CA)

(21) Appl. No.: 18/620,435

(22) Filed: Mar. 28, 2024

Related U.S. Application Data
(60) Provisional application No. 63/492,857, filed on Mar. 29, 2023.

(51) Int. Cl. G06F 17/11

(52) U.S. Cl. CPC G06F 17/11

(57) ABSTRACT

Systems and methods that comprise: capturing business objectives from a user, including a weight of each business objective; searching possible solutions in a heuristic way, enumerating all the options; evaluating each solution against the objectives being targeted at each of the product structure; selecting a result that satisfies the given objectives the most; and outputting the result with the user.

### CROSS-REFERENCE TO RELATED APPLICATIONS

This application claims priority from U.S. Provisional Application No. 63/492,857 filed Mar. 29, 2023, the disclosure of which is hereby incorporated by reference in its entirety.

### BACKGROUND

Optimization problems involving scores of variables (if not more) often require complex algorithms, which take up time and resources to complete, even if the there is only one main optimization objective. An alternative approach is to apply a heuristic, or greedy algorithm, which provides a solution in real time. While a greedy algorithm may not produce an optimal solution, a greedy heuristic can yield locally optimal solutions that approximate a globally optimal solution in a reasonable amount of time.

Such a heuristic provides a solution for a single, particular objective. However, if a user seeks a different objective for optimization, the heuristic provides a solution that is less than optimal, since it is not configured to optimize for a different objective. One alternative is to formulate an optimization algorithm for the new objective; however, such a process takes time and resources to obtain a solution, when time is of the essence.

Moreover, not only can a user not redefine the objective for a heuristic, but the user cannot seek an optimal solution with multiple objectives, since the heuristic is not configured to accept multiple objectives.

There is a need to find a technical solution that allows a user to seek an objective that is different from the designed objective of a heuristic. There is also a need to allow a user to input multiple objectives for a heuristic that is designed for one particular objective.

### BRIEF SUMMARY

The systems and methods disclosed herein address the problems cited above, by providing a technical solution which is an intermediary system between a user and heuristic, which allows for the input of objective(s) by the user that is/are not necessarily the main objective of the heuristic. The system converts the user-based objective(s) into an input that can be used by the existing heuristic, thereby providing a real-time solution to a complex optimization problem.

In addition, the systems and methods disclosed herein can also be designed to provide a global optimum from a heuristic, rather than relying on an optimization algorithm that requires longer computing time and more computational resources.

Instead of indirectly making a combination of control settings that may get close to what a user is expecting, the systems and methods disclosed herein directly make sourcing choices given a set of objectives. Moreover, when all objectives cannot be met together (for example, there are conflicts between objectives), then the user can assign weights to the objectives, for which a user interface can be used. Furthermore, the systems and methods disclosed herein do not use traditional optimization techniques. Therefore, the systems and methods disclosed herein are very fast and improve the efficiency of computer operations, allowing for solutions in real time. These systems and methods can also provide explanations as to how decisions are made.

Disclosed herein are systems and methods that comprise: capturing one or more objectives from a user, including a weight of each objective; searching possible solutions in a heuristic way, while enumerating all options; evaluating each solution against the objectives being targeted at each stage of a product structure; selecting a result that satisfies the given objectives the most; and outputting the result to the user via an output user interface. Furthermore, the user can iteratively adjust the objectives.

In one aspect, a computer-implemented method, is provided that includes a heuristic designed for optimization based on a single objective, an interface that converts one or more objectives provided by a user into a single criterion based on associated weights of each of the one or more objectives, and execution of the heuristic in communication of the interface, using the single criterion.

The computer-implemented method may also include iterative execution of the heuristic with the interface. In the computer-implemented method, the user may provide a plurality of objectives. In the computer-implemented method, each of the one or more objectives may be distinct from the single objective.

The computer-implemented method may also include the steps of: receiving, by a processor, the one or more objectives and the associated weights, identifying, by the processor, one or more criteria for each objective, combining, by the processor, the one or more criteria into the single criterion based on the associated weights, identifying, by the processor, one or more solution choices, and selecting, by the processor, an optimal solution choice based on the single criterion. The computer-implemented method may further include the steps of: evaluating, by the processor, the optimal solution choice against the one or more objectives and the associated weights, and outputting, via an output user interface, the optimal solution choice to the user. Other technical features may be readily apparent to one skilled in the art from the following figures, descriptions, and claims.

In one aspect, a system is provided that includes a heuristic designed for optimization based on a single objective. The system also includes an interface in communication with the heuristic. The system also includes a processor. The system also includes a memory storing instructions that, when executed by the processor, configure the system to convert one or more objectives provided to the interface into a single criterion based on associated weights of each of the one or more objectives, and execute the heuristic based on the single criterion.

The system may also be further configured to iteratively execute the heuristic with the interface. In the system, a plurality of objectives may be provided. In the system, the one or more objectives may be distinct from the single objective.

The system may be further configured to receive, by the processor, the one or more objectives and the associated weights, identify, by the processor, one or more criteria for each objective, combine, by the processor, the one or more criteria into the single criterion based on the associated weights, identify, by the processor, one or more solution choices, and select, by the processor, an optimal solution choice based on the single criterion. The system may be further configured to: evaluate, by the processor, the optimal solution choice against the one or more objectives and the associated weights, and output, via an output user interface, the optimal solution choice to the user. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to convert one or more objectives provided to an interface into a single criterion, based on associated weights of each of the one or more objectives, and execute a heuristic in communication with the interface, based on the single criterion, where the heuristic is designed for optimization based on a single objective.

The non-transitory computer-readable storage medium may also be configured to iteratively execute the heuristic with the interface. A plurality of objectives may be provided for non-transitory computer-readable storage medium. Furthermore, each of the one or more objectives may be distinct from the single objective.

In the non-transitory computer-readable storage medium, the computer may be further configured to receive, by a processor, the one or more objectives and the associated weights, identify, by the processor, one or more criteria for each objective, combine, by the processor, the one or more criteria into the single criterion based on the associated weights, identify, by the processor, one or more solution choices, and select, by the processor, an optimal solution choice based on the single criterion. In the non-transitory computer-readable storage medium, the computer may be further configured to evaluate, by the processor, the optimal solution choice against the one or more objectives and the associated weights, and output, via an output user interface, the optimal solution choice to the user. Other technical features may be readily apparent to one skilled in the art from the following figures, descriptions, and claims. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter will become apparent from the description, the drawings, and the claims.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for Objective-Driven Automated Sourcing Intelligence, in accordance with one embodiment.

FIG. 2 illustrates a system in accordance with one embodiment.

FIG. 3 illustrates a system in accordance with one embodiment.

FIG. 4 illustrates an Objective-Driven Automated Sourcing Intelligence (OASI) solver in accordance with one embodiment.

FIG. 5 illustrates an Objective-Driven Automated Sourcing Intelligence (OASI) solver in accordance with one embodiment.

FIG. 6 illustrates a flowchart accordance with one embodiment.

FIG. 7 illustrates a flowchart accordance with one embodiment.

FIG. 8 illustrates an example in accordance with one embodiment.

FIG. 9 illustrates further details of the example shown in FIG. 8.

FIG. 10 illustrates an input user interface in accordance with one embodiment.

FIG. 11 illustrates an example of an objective selected in an input user interface in accordance with one embodiment.

FIG. 12 illustrates an output user interface in relation to FIG. 11.

FIG. 13 illustrates an example of an objective selected in an input user interface in accordance with one embodiment.

FIG. 14 illustrates an output user interface in relation to FIG. 13.

FIG. 15 illustrates an example of a mixture of objectives selected in an input user interface in accordance with one embodiment.

FIG. 16 illustrates an output user interface in relation to FIG. 15.

FIG. 17A illustrates an output metric for three different objectives, in accordance with one embodiment.

FIG. 17B illustrates an output metric for three different objectives, in accordance with one embodiment.

FIG. 17C illustrates an output metric for three different objectives, in accordance with one embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

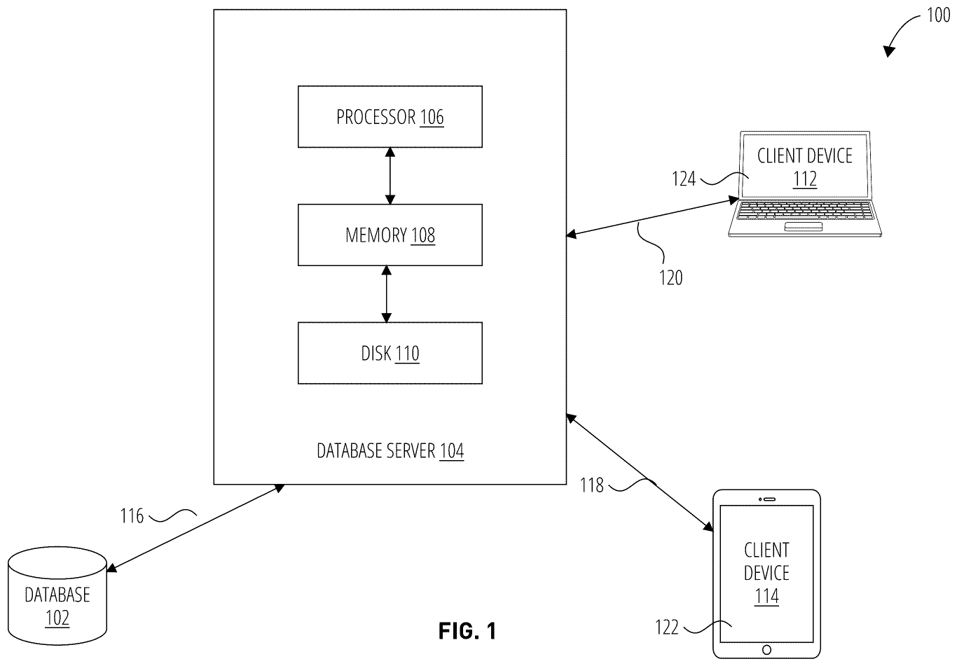

FIG. 1 illustrates an example of a system 100 for Objective-Driven Automated Sourcing Intelligence.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also comprise a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

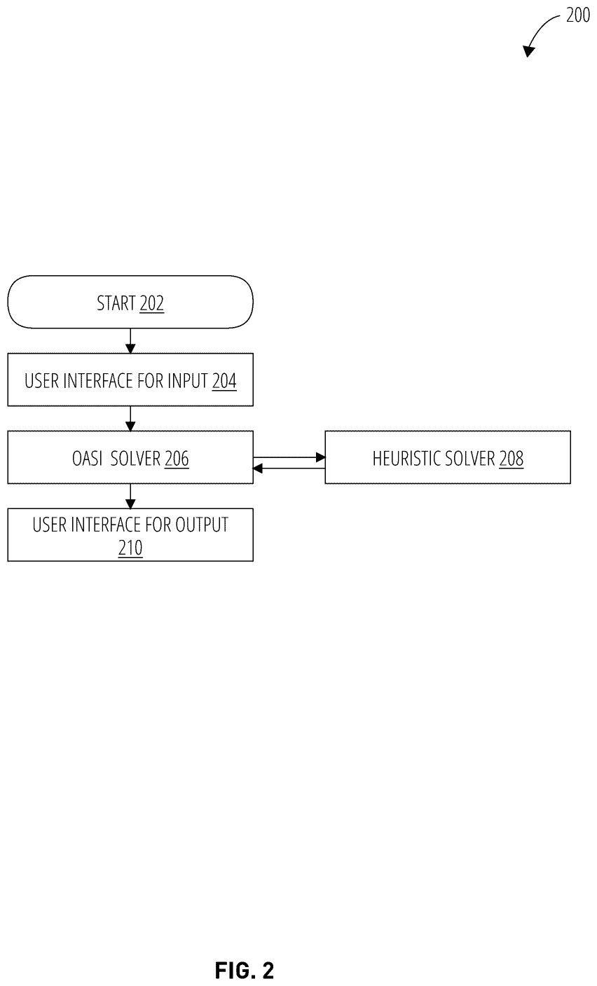

FIG. 2 illustrates a system 200 in accordance with one embodiment. The system comprises: a user interface (UI) for input 204; an OASI solver 206, a Heuristic Solver 208; and a UI for output 210.

The UI for input 204 can interact with a user and the OASI solver. The UI for input 204 may provide a user interface for the input of objectives and their respective weights. The UI for input 204 can transfer the input from the user to the OASI solver 206.

The OASI solver 206 can interact with the UI for input 204 (as described above) and the Heuristic Solver 208. The OASI solver 206 can convert the objectives and weights (received from the UI for input 204) into a set of criteria that can be used when comparing alternatives. The OASI solver 206 may specify which solution is better (that is, by specifying a comparator) and can eliminate unwanted choices as an optimization.

The Heuristic Solver 208 receives the single criteria from the OASI solver 206. The Heuristic Solver 208 can identify solution options, and may compare the various solution options using the single criteria provided by the OASI solver 206 and subsequently can choose the best solution. Alternatively, the Heuristic Solver 208 can revert to the OASI solver 206 to select the best solution based on the single criterion.

The UI for output 210 can provide a user interface for the results. It can be web-based/mobile, for example.

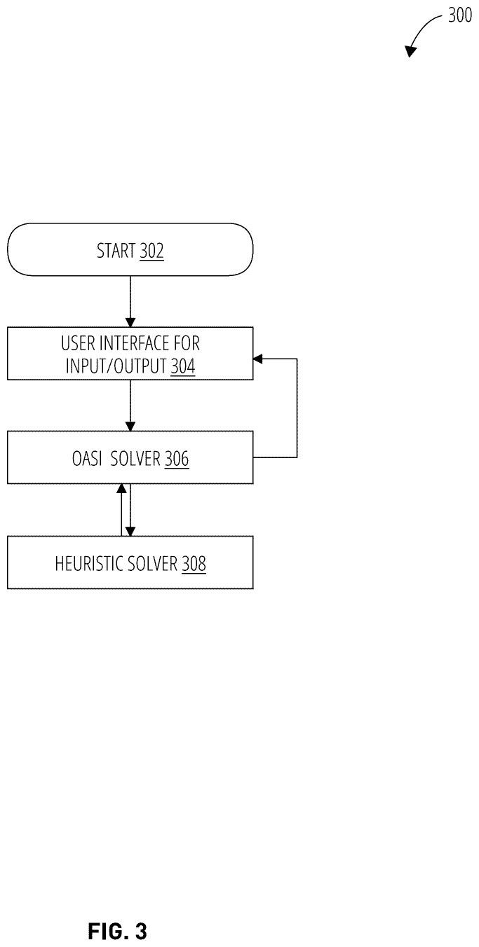

FIG. 3 illustrates a system 300 in accordance with one embodiment. The system comprises: a user interface (UI) 304, an OASI solver 306, and a heuristic solver 308.

System 300 is similar to that of system 200, except the user interface is the same for input and output. In system 200, the user interface for input is decoupled from the user interface for output.

The UI 304 can interact with a user and the OASI solver. The UI 304 may provide a user interface for the input of objectives and their respective weights, by a user. The UI 304 can transfer the input from the user to the OASI solver 306.

The OASI solver 306 can interact with the UI 304 for input (as described above) and the Heuristic Solver 308. The OASI solver 206 can convert the objectives and weights (received from the UI 304), into a set of heuristics that can be used when comparing alternatives. The OASI solver 306 may specify which solution is better (that is, by specifying a comparator) and can eliminate unwanted choices as an optimization.

The Heuristic Solver 308 receives heuristics or comparators from the OASI solver 306. The Heuristic Solver 308 can identify solution options, and may compare the various solution options using heuristics provided by the OASI solver 306 and can subsequently choose the best solution. Alternatively, the Heuristic Solver 308 can revert to the OASI solver 306 to select the best solution based on the single criterion. The UI 304 can provide a user interface for the results. It can be web-based/mobile, for example.

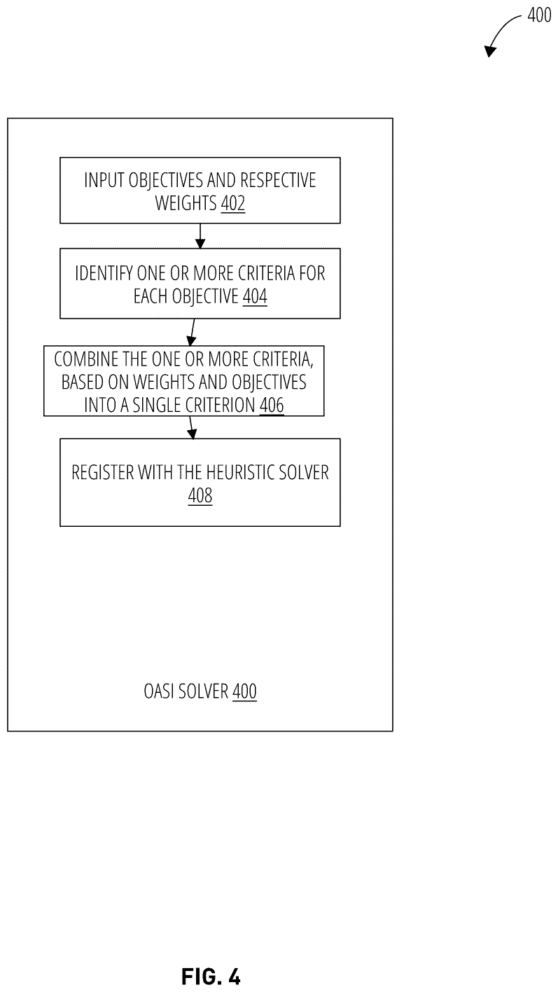

FIG. 4 illustrates an OASI solver 400 in accordance with one embodiment.

The OASI solver 400 receives objectives and weights at 402. It then identifies one or more criteria for each objective at 404. Subsequently, OASI solver 400 combines the one or more criteria, based on the weights, into a single criterion at 406. The OASI solver 400 may then register with the Heuristic Solver at 408, so that the Heuristic Solver can call upon the OASI solver 400 to evaluate possible solutions.

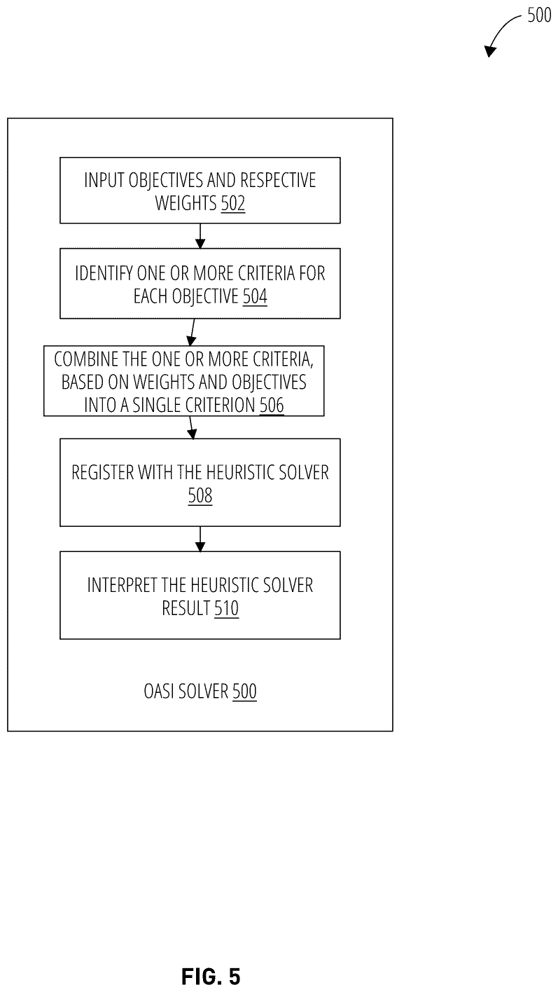

FIG. 5 illustrates an OASI solver 500 in accordance with one embodiment.

The OASI solver 500 receives objectives and weights at 502. It then identifies one or more criteria for each objective at 504. Subsequently, OASI solver 500 combines the one or more criteria, based on the weights, into a single criterion at 506. The OASI solver 500 may then register with the Heuristic Solver at 508, so that the Heuristic Solver can call upon the OASI solver 500 to evaluate possible solutions. This can be followed by interpretation of the heuristic solver result at block 510.

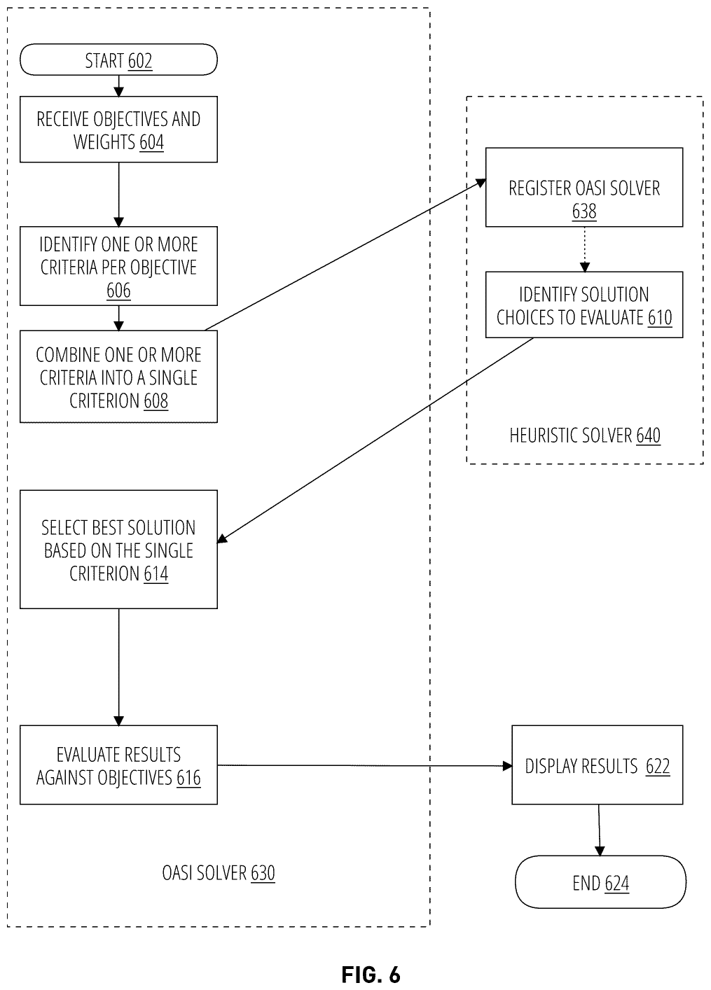

FIG. 6 illustrates a flowchart in accordance with one embodiment. The flowchart in FIG. 6 can represent further details of system 300 shown in FIG. 3, in which the dynamic interchange between OASI Solver 630 and Heuristic Solver 640 is described. As discussed previously Heuristic Solver 640 comprises a greedy algorithm.

A user provides objectives, and their respective weights to the OASI Solver 630, at block 604. One or more criteria per objective is then identified at block 606. The one or more criteria are then combined into a single criterion, based on the weights, at block 608.

At this juncture, the OASI Solver 630 registers with the Heuristic Solver 640 at block 638. This is an indication to the Heuristic Solver 640 that it is to call upon the OASI Solver 630 during its operation.

It is at block 610, where the Heuristic Solver 640 identifies solution choices to evaluate, that the Heuristic Solver 640 calls on the OASI Solver 630, which selects the best solution (of the solution choices) based on the single criterion (obtained at block 608). That is, rather than having the Heuristic Solver 640 select the best solution, it is the OASI Solver 630 that does the selecting.

The comparison is then returned to the OASI Solver 630, which then selects the best solution, at block 614, based on the single criterion The results can then be evaluated against objectives at block 616. The results are then displayed to the user at block 622 and the process ends at 624.

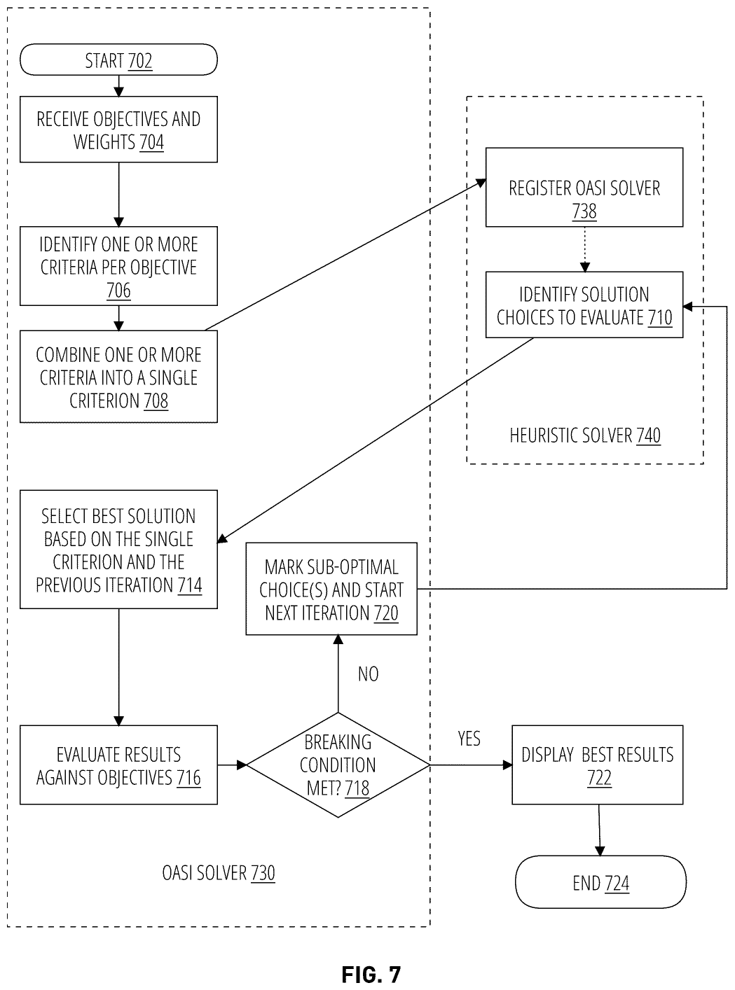

FIG. 7 illustrates a flowchart in accordance with one embodiment. The flowchart in FIG. 7 can represent further details of system 300 shown in FIG. 3, in which the dynamic interchange between OASI Solver 730 and Heuristic Solver 740 are described. As discussed previously Heuristic Solver 740 comprises a greedy algorithm.

A user provides objectives, and their respective weights to the OASI Solver 730, at block 704. One or more criteria per objective is then identified at block 706. The one or more criteria are then combined into a single criterion, based on the weights, at block 708.

At this juncture, the OASI Solver 730 registers with the Heuristic Solver 740 at block 738. This is an indication to the Heuristic Solver 740 that it is to call upon the OASI Solver 730 during its operation. It is at block 710, where the Heuristic Solver 740 identifies solution choices to evaluate, that the Heuristic Solver 740 calls on the OASI Solver 730, which selects the best solution (of the solution choices) based on the single criterion (obtained at block 708) and a previous iteration. That is, rather than having the Heuristic Solver 740 select the best solution, it is the OASI Solver 730 that performs the selection.

The comparison is then returned to the OASI Solver 730, which then selects the best solution, at block 714, based on the single criterion and the previous iteration of the Heuristic Solver 732. The results can then be evaluated against objectives at block 716.

At this point, there is an option to take advantage of the OASI Solvers 730 to find a global optimum, by iterating through the choices. If a breaking condition is met (‘yes’ at decision block 718), then the best results are displayed to the user at block 722 and the process ends at 724. If the breaking condition is not met (‘no’ at decision block 718), then sub-optimal choices are marked and the next iteration begins at block 720. The iteration process is repeated until the breaking condition at decision block 718 is satisfied.

The breaking condition at decision block 718 is a flexible criterion that comprises a set of breaking conditions which decided whether or not to break the iteration. The breaking conditions can include: whether or not the results are satisfactory enough in meeting the objectives; if too many attempts made in the iteration; or whether or not the current result is an improvement over the previous result. An example of using the OASI Solver 730 and the Heuristic Solver 740 in an iterative manner to find a global optimum, is provided below.

The heuristic solver is designed with a particular objective. By itself, the heuristic solver can only solve for its designated objective. It cannot solve for multiple objectives, nor can it provide meaningful results for an objective that is different from its designated objective.

The OASI solver is an interface, that converts a user input comprising one or more objectives and respective weights, into a singular criterion that can be used by the heuristic solver; the one or more objectives are distinct from the objective designated for the heuristic solver.

Instead of designing a new heuristic solver for each and every distinct objective of an optimization problem, the OASI solver provides a technical solution by converting user input into a format that can be used by the heuristic solver.

In an embodiment, there can be ‘n’ objectives (‘Obj’), with the ‘i^{th}’ objective labeled as Objᵢ, wherein 1≤i≤n. The total number of objectives can be between 1 and any finite integer.

A metric associated each objective be represented by:

M_{i,j}∀0<i<n, i∈Z⁺ and 0<j<m, j∈Z⁺, where ‘m’ is the total number of solution options available for each objective. As an example, an objective can be minimization of cost, and an associated metric can be the cost. In addition, a base value is set to 10.

A normalized metric (‘NM’) for a specific objective ‘i’ and solution option ‘j’ can be defined as:

$${NormM}_{i , j} = \frac{{M}_{i , j}}{{{\sum }_{j = 1}}_{} {M}_{i , j}} * Base \qquad EQ . ( 1 )$$

Let Scaling factor for Objective ‘i’ (Objᵢ) be denoted by ‘Sfᵢ’. The scaling factor for each objective is used to scale/normalize metrics across objectives so that they can be meaningfully combined with each other:

$${Sf}_{i} = {Base}^{( n - i + 1 )} \qquad EQ . ( 2 )$$

Let a Weight of each objective be defined by ‘wᵢ’. The weight of each objective is defined as the contribution of each objective to the final combined criteria. A Combined Criteria for a solution option ‘j’ is defined as:

$${CombinedCriteria}_{j} = {\sum }_{i = 1} {NormM}_{i , j} * {Sf}_{i} * {w}_{i} \qquad EQ . ( 3 )$$

Given all combined criteria, a single combined criteria with a minimum metric is chosen to be fed to the heuristic solver.

The Combined Criteria for a solution option ‘j’ provides a quantitative combined view of all the objectives. Furthermore, a Combined Criteria can be modelled as a function of differed metrics, scaling factor and weights across different objectives. An example below illustrates this function can be a summation of weighted scaled metrics across all objectives. In addition, the objectives may be business-dependent and can be modelled as costs across different solution option(s).

### Example

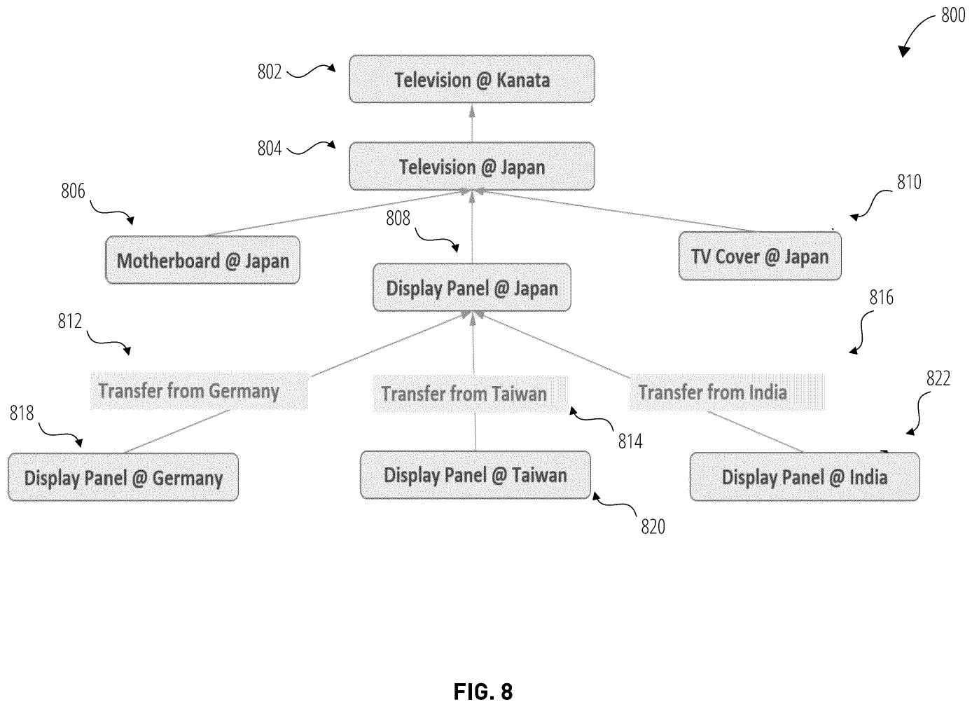

FIG. 8 illustrates an example 800 in accordance with one embodiment. FIG. 8 illustrates a simple product structure of televisions for sale in Kanata, the site of a TV seller. Kanata is a retail site where the television is sold, as shown in 802. However, the television is actually manufactured in Japan, as shown in 804. The television assembly, which takes place in Japan, requires three major components: a motherboard 806, a display panel 808 and TV cover 810. The motherboard 806 and the TV cover 810 are each made at the Japan site. However, the display panel 808 is transferred from either Germany (812), Taiwan (814) or India (816).

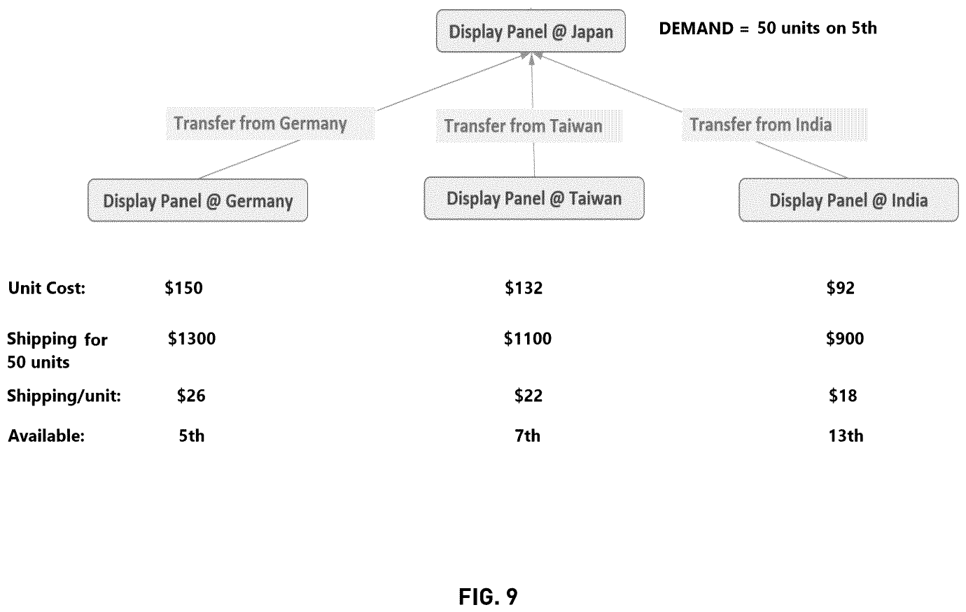

FIG. 9 illustrates further details of the example shown in FIG. 8, in which a demand of 50 units of a display is requested in Japan on the 5th of a given month. For each location (Germany, Taiwan and India), the following information is provided: the unit cost of each panel, the shipping cost for 50 panels, the shipping cost per panel, and the date of availability. The unit cost is how much it costs to produce a single panel.

As it can be seen, the unit cost and shipping cost per unit, are both the highest for Germany, and lowest for India, with Taiwan in between the two. As for availability, Germany is fastest, while India is the slowest, with Taiwan in between. Panels from Germany will be on-time (0 days late), whereas the panels from Taiwan will be 2 days late, and panels from India will be 8 days late. This can be summarized in the table below:

TABLE 1

| Item | Germany | Taiwan | India |
|---|---|---|---|
| Unit cost | $150 | $132 | $92 |
| Shipping/unit | $26 | $22 | $18 |
| Effective purchase cost | $176 | $154 | $110 |
| Lateness | 0 | 2 days | 8 days |

At this point, a number of objectives, and respective metrics can be identified:

| Objective | Metric |
|---|---|
| On-Time (OT) | Lateness |
| Purchase Cost (PC) | Unit cost + Shipping/unit |

That is, one objective can be to have panels arrive as close to the demand date as possible—that is, to be on time (OT), as much as possible. A metric associated with this objective can be the lateness of delivery. Furthermore, another objective can be the purchase cost (PC), and the associated metric can be the total of the unit cost and shipping/unit cost of a panel.

In order to properly combine the various items with respect to the objectives and metrics, each item is normalized according to EQ. (1). Define a function, designated by ‘H’, for each objective as follows:

H(PC)=Norm(Unit cost+Shipping per unit cost)

H(OT)=Norm(Lateness)

Using a scale factor of 10, and Table 1, the normalized values for each option are:

| Normalized (%) | Germany | Taiwan | India |
|---|---|---|---|
| H(PC) | 4 | 3.5 | 2.5 |
| H(OT) | 0 | 2 | 8 |

The scaling factor for each objective, will depend on the priority of each objective.

### Scenario 1

On Time is 1st priority, Purchase cost is 2nd priority. The total number of objectives is 2 (n=2). From EQ. (2), the scaling factor for OT (i=1) is 100, and the scaling factor for PC (i=2) is 10. Furthermore, each objective is of equal weight:

| Priority | Objective | Weights |
|---|---|---|
| 1 | On Time | 100% |
| 2 | Purchase Cost | 100% |

After combining the criteria for each country:

| | | | | Scaling |
|---|---|---|---|---|
| | Germany | Taiwan | India | Factor |
| On Time | 0 | 200 | 800 | 100 |
| Purchase | 40 | 35 | 25 | 10 |
| Cost | | | | |
| Combined | 40 | 235 | 825 | |

In this case, the lowest total is for Germany.

### Scenario 2

On Time is 2nd priority, Purchase cost is 1st priority. The total number of objectives is 2 (n=2). From EQ. (2), the scaling factor for OT (i=2) is 10, and the scaling factor for PC (i=1) is 100. Furthermore, each objective is of equal weight:

| Priority | Objective | Weights |
|---|---|---|
| 2 | On Time | 100% |
| 1 | Purchase Cost | 100% |

After combining the criteria for each country:

| | Germany | Taiwan | India | Scaling Factor |
|---|---|---|---|---|
| Purchase Cost | 400 | 350 | 250 | 100 |
| On Time | 0 | 20 | 80 | 10 |
| Combined | 400 | 370 | 335 | |

In this case, the lowest total is for India.

### Scenario 3

On Time is 2nd priority, Purchase cost is 1st priority. The total number of objectives is 2 (n=2). From EQ. (2), the scaling factor for OT (i=2) is 10, and the scaling factor for PC (i=1) is 100. This time, the Purchase cost has half the weight of On Time:

| Priority | Objective | Weights |
|---|---|---|
| 2 | On Time | 100% |
| 1 | Purchase Cost | 50% |

After combining the criteria for each country:

| | Germany | Taiwan | India | Scaling Factor |
|---|---|---|---|---|
| Purchase Cost | 200 | 175 | 125 | 100 |
| On Time | 0 | 20 | 80 | 10 |
| Combined | 200 | 195 | 200 | |

In this case, the lowest total is for Taiwan.

### Example of Iterative Process

In an embodiment, a global optimum can be found by using the OASI solver and the Heuristic solver in an iterative manner, as illustrated in FIG. 7.

In an example, there are two demands, D1 and D2: D1 is a demand of quantity 50 television panels, with a due date of March 5th, while D2 is a demand of quantity 50 television panels, with a due date of April 5th. The objective is On Time (OT). In this example, there are two sources: Germany and Taiwan, each with the following properties:

| | Germany | |
|---|---|---|
| | Inventory of 50 panels prior to March 5th | Taiwan |
| March | No production of panels | 5 days late |
| April | No production of panels | 20 days late |

That is, the German source has 50 panels in inventory prior to March 5th, but will not produce any further panels in March or April. The Taiwanese source, on the other hand, can provide panels 5 days after the Demand deadline in March, and 20 days late in April.

Execution of the OASI Solver 730 and Heuristic Solver 740 in the embodiment illustrated in FIG. 7, the results of two iterations are as follows:

| Demand | Iteration #1 | Iteration #2 |
|---|---|---|
| D1 | Use Germany. Existing inventory | Use Taiwan. 5 days late |
| | of panels is On Time | |
| D2 | Use Taiwan (Germany has no panels | Use Germany. Existing |
| | to ship). 20 days late | inventory On Time |

In the first iteration, the OASI Solver 730 selects Germany to fill Demand D1, since it is On Time, and Taiwan to fill Demand D2, which is 20 days late. In fact, there is no other choice for D2, other than Taiwan, since the German source has depleted its source of panels in the March shipment, and in April, has no panels produced to ship.

As this is the first iteration, no breaking condition is met. A second iteration is performed, in which the sub-optimal choice (Taiwan) is marked. The result in the second iteration is fulfilment of Demand D1 by Taiwan, which is 5 days late, and fulfillment of Demand D2 by Germany, which On Time. Iteration 2 has less overall lateness and meets the objective of On Time better than Iteration #1. Here, the breaking condition can be whether the result better than that obtained from the previous iteration. Here, the answer is yes at decision block 718, and the process stops any further iteration. The best results (that is, those of Iteration #2) are displayed at block 722, and the process ends at 724. The OASI Solver 730

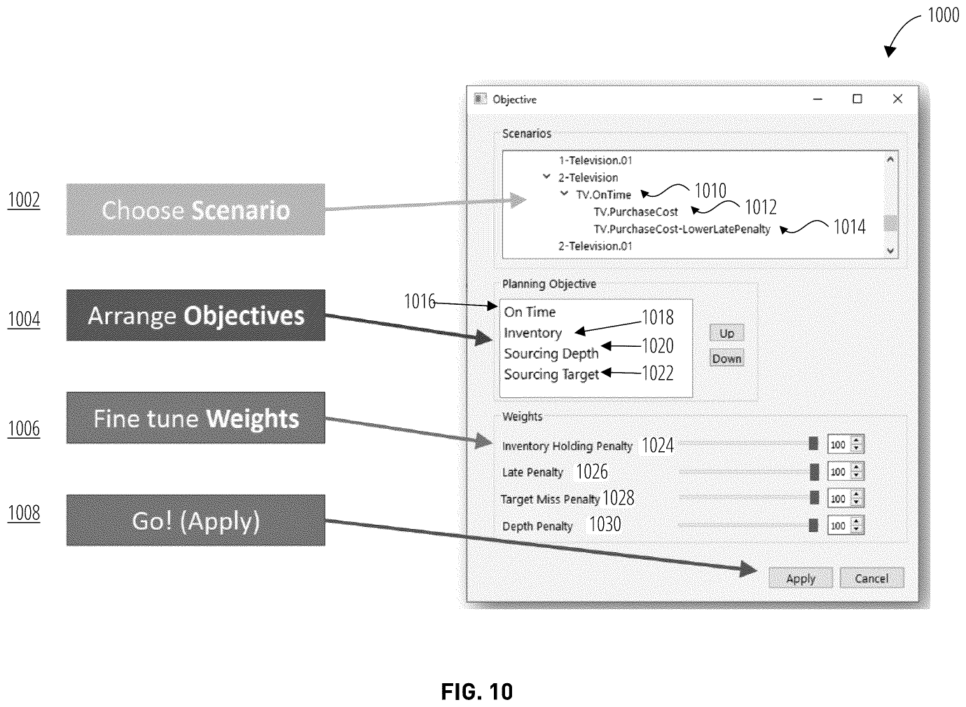

FIG. 10 illustrates an input user interface 1000 in accordance with one embodiment. A user is presented with input user interface 1000 which forms part of an OASI solver, as shown in FIG. 2. The input user interface 1000 allows a user to input one or more objectives, and obtain, in real-time, a near-optimal solution.

First, at 1002, a user can choose a scenario. In FIG. 10, the choice of scenarios is listed with respect to the example shown in FIG. 8—namely, the assembly of televisions. One scenario 1010 involves assembly on time; another scenario 1012 involves assembly of televisions with respect to purchase cost; and a third scenario 1014 involves assembly of televisions with respect to a combination of purchase cost and lower late penalty.

Next, at 1004, the user can arrange one or more objectives. In FIG. 10, the choice of planning objectives is listed with respect to the example shown in FIG. 8. Planning objectives include “On Time” (1016), “Inventory” (1018), “Sourcing Depth” (1020) and “Sourcing Target” (1022).

Next, at 1006, the user can arrange the weights of each of the objectives selected at 1004. The higher the weight, the more important the objective. This allows for a hierarchy of objectives, rather than one single objective, to be selected. Furthermore, each weight may have a sliding scale, from ‘0’ to ‘100’.

In FIG. 10, the weight for inventory (1018) can be tied to the inventory holding penalty sliding scale (1024); the weight for “on time” (1016) can be tied to the late penalty sliding scale (1026); the weight for “sourcing depth” (1020) can be tied to the depth penalty sliding scale (1030); and the weight for “sourcing target” (1022) can be tied to the target miss penalty sliding scale (1028).

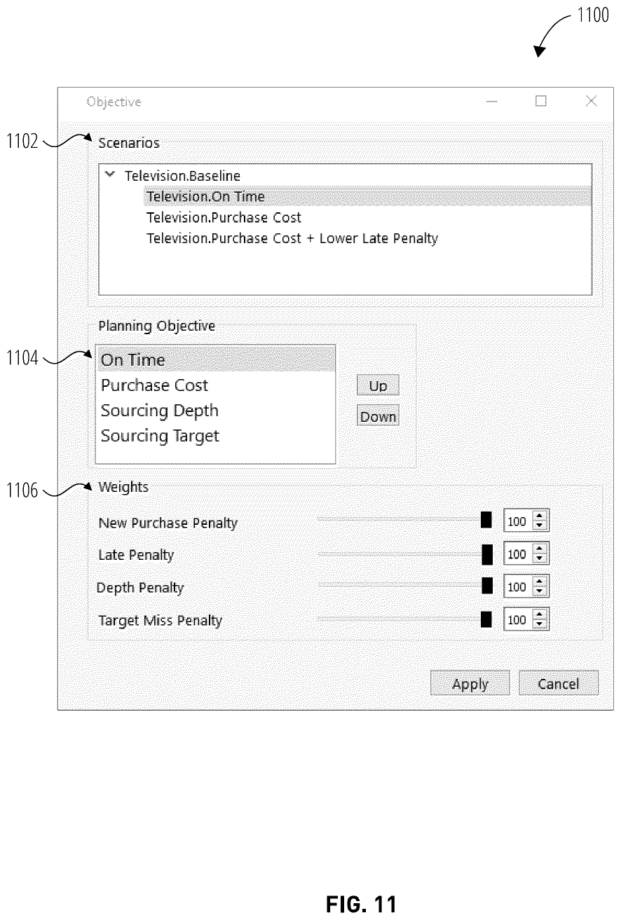

FIG. 11 illustrates an example of an objective selected in an input user interface 1100 in accordance with one embodiment.

In the input user interface 1100, the user has selected the scenario 1102 as “Television on time”, and has also selected only one objective 1104 to optimize—namely, “On Time”. As such, weights 1106 are not configured in this case, since the On Time default objective is 100%. This means “on time” is preferred over other objectives.

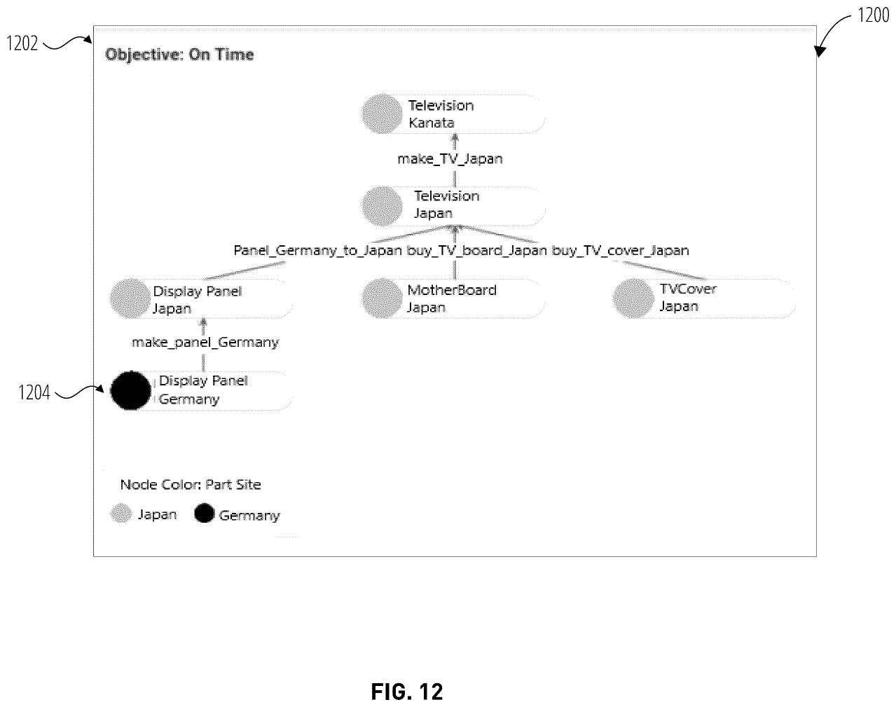

FIG. 12 illustrates an output user interface 1200 in relation to FIG. 11.

The output user interface 1200 provides a real-time result based on the objectives input at user interface 1100 in FIG. 11. Namely, that for a sole “on time” objective 1202, the result for sourcing the display panel is Germany 1204. With respect to FIG. 8, it is clear that neither Taiwan nor India can be the result, since both sourcing locations will not provide a display panel on time. The OASI solver, working in tandem with the heuristic solver, provides an optimal answer for the selected objective of ‘On Time’.

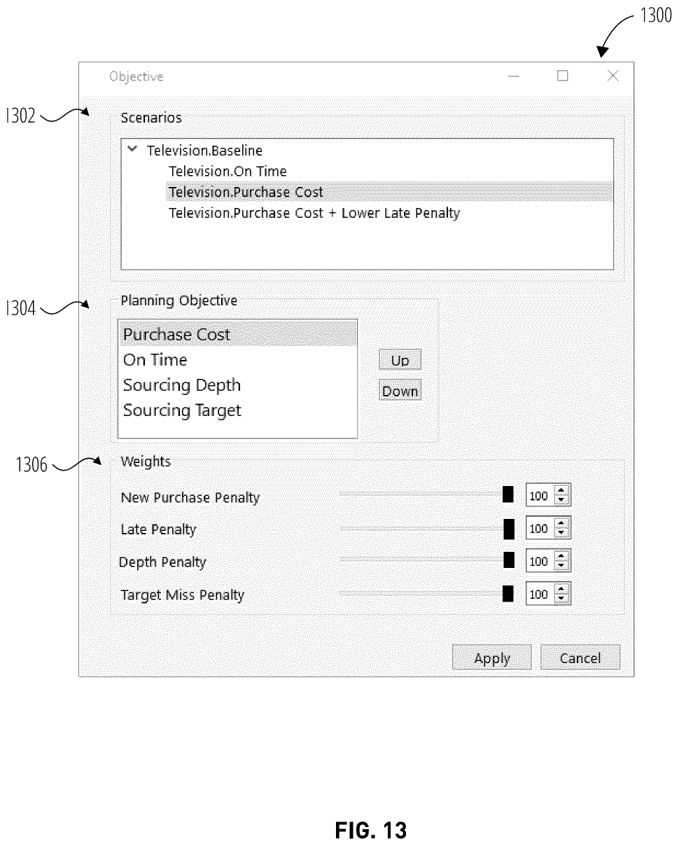

FIG. 13 illustrates an example of an objective selected in an input user interface 1300 in accordance with one embodiment.

In the input user interface 1300, the user has selected the scenario 1302 as “Television purchase cost”, and has also selected only one objective 1304 to optimize—namely, “Purchase Cost”. As such, weights 1306 are not configured in this case, since the Purchase Cost objective is 100%. This means that it is acceptable to be late if the purchase cost is lower.

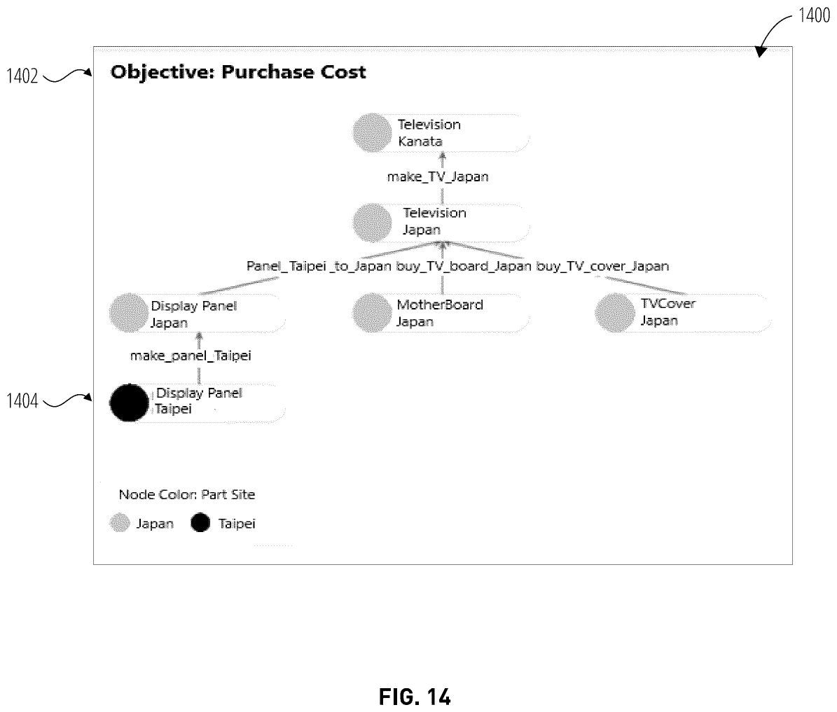

FIG. 14 illustrates an output user interface 1400 in relation to FIG. 13.

The output user interface 1400 provides a real-time result based on the objectives input at input user interface 1300 in FIG. 13. Namely, that for a sole purchase cost objective 1402, the result for sourcing the display panel is Taipei (Taiwan) 1404. The OASI solver, working in tandem with the heuristics, provides an optimal answer for the selected objective of ‘Purchase Cost’. Note that the while the heuristic solver is configured for an ‘on time’ objective, the OASI solver takes the input of “purchase cost” and translates it into an input that is meant for the heuristic solver, and the output, in real-time, is a result that meets the objective of “purchase cost” (which is not the objective of the heuristic solver).

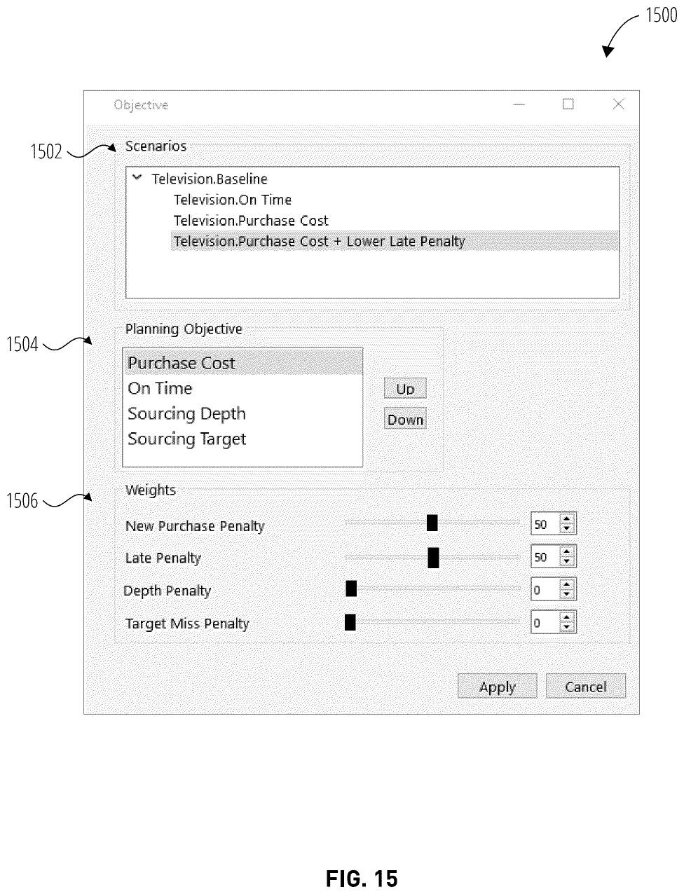

FIG. 15 illustrates an example of a mixture of objectives selected in an input user interface 1500 in accordance with one embodiment.

In the input user interface 1500, the user has selected the scenario 1502 as “Television purchase cost+Lower Late Penalty”, and has also selected objective 1504 to optimize—namely, “Purchase Cost”. However, it is possible to accept additional lateness if it lowers the purchase cost in this case. In this case, the weights for the late penalty and new penalty are adjusted to both equal 50%, while the respective weight for the depth penalty and target miss penalty is set to zero.

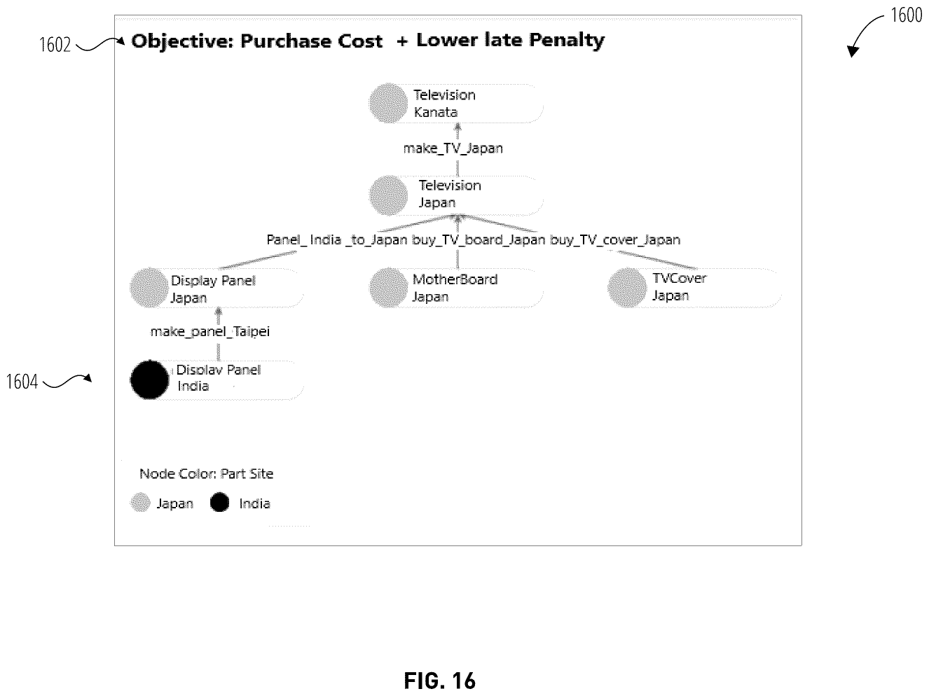

FIG. 16 illustrates an output user interface 1600 in relation to FIG. 15.

The output user interface 1600 provides a real-time result based on the objectives input at input user interface 1500 in FIG. 15. Namely, that for the objective 1602 of purchase cost and lower late penalty, the result for sourcing the display panel is India 1604. The OASI solver, working in tandem with the heuristics, provides an optimal answer for the selected combined objective of ‘Purchase Cost’ and “Lower Late Penalty”.

Note that the while the heuristic solver is configured for an ‘on time’ objective, the OASI solver takes the input of combined “purchase cost” and “lower late penalty” and translates it into an input that is meant for the heuristic solver, and the output, in real-time, is a result that meets the combined objectives of “purchase cost” and “Lower late penalty”.

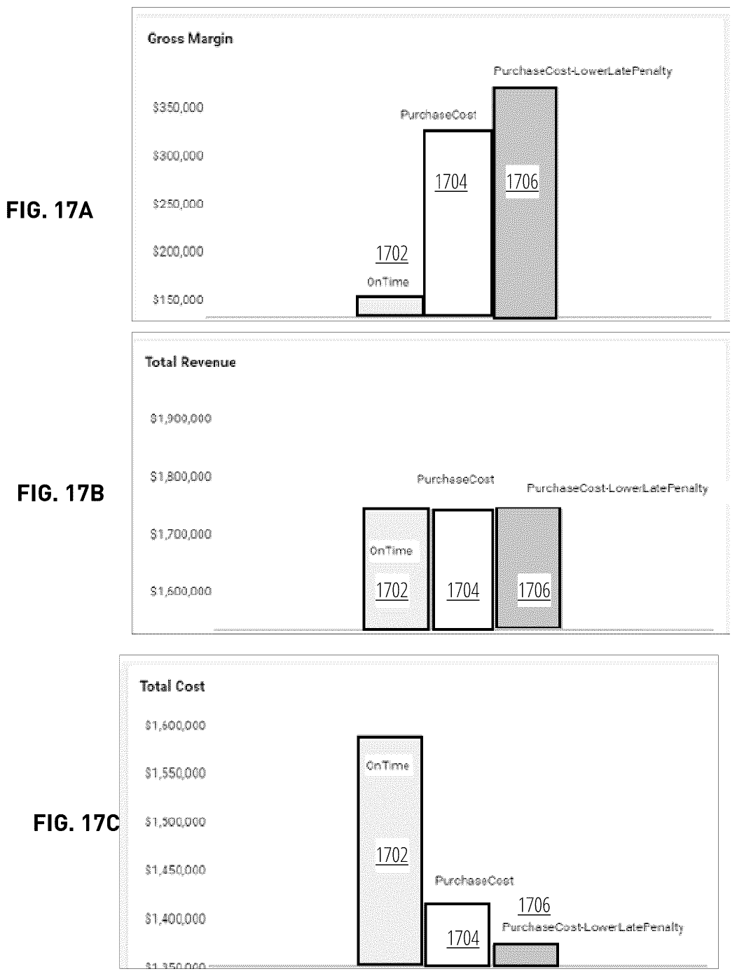

FIG. 17A illustrates gross margin (an output metric) for each of the three different objectives: on time 1702, purchase cost 1704, and purchase cost & lower late penalty 1706, in accordance with one embodiment. That is, for each of the objectives shown in FIG. 11, FIG. 13 and FIG. 15, the resulting gross margin can be calculated. In FIG. 17A, with all things being equal (such as product structure, demands, safety stock requirements), the lowest gross margin is obtained for an on time objective, while the highest gross margin is obtained for a combined objective of purchase cost and lower late penalty.

FIG. 17B illustrates total revenue (an output metric) for each of the three different objectives: on time 1702, purchase cost 1704, and purchase cost & lower late penalty 1706, in accordance with one embodiment. That is, for each of the objectives shown in FIG. 11, FIG. 13 and FIG. 15, the resulting total revenue can be calculated. In FIG. 17B, with all things being equal (such as product structure, demands, safety stock requirements), the total revenue is identical of each objective.

FIG. 17C illustrates total cost (an output metric) for each of the three different objectives: on time 1702, purchase cost 1704, and purchase cost & lower late penalty 1706, in accordance with one embodiment. That is, for each of the objectives shown in FIG. 11, FIG. 13 and FIG. 15, the resulting total cost can be calculated. In FIG. 17C, with all things being equal (such as product structure, demands, safety stock requirements), the total cost is highest for on time 1702, while least for purchase cost & lower late penalty 1706.

There are a number of benefits that accrue from using the OASI solver, in addition to those already mentioned. For example, with the same master data of the planning (such as product structure, demands, safety stock requirements) it is possible for a user to configure objectives (and perhaps weights too) to customize a solution based on business requirements.

For example, if an entity has a focus on revenue (and customer satisfaction) in Q1, it may choose the relevant objective(s), such as “On Time” (since there is no lateness). On the other hand, if the entity seeks to reduce costs in order to improve margins (FIG. 17A) in a different quarter, it may use a different set of objectives, such as purchase cost and purchase cost & lower late penalty 1706. Such an objective-based interface is available without having to execute a full optimizer since a heuristic solver is used, which is proven to be much faster than an optimization approach.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
a heuristic designed for optimization based on a single objective;
an interface that converts one or more objectives provided by a user into a single criterion based on associated weights of each of the one or more objectives; and
execution of the heuristic in communication of the interface, using the single criterion.

2. The computer-implemented method of claim 1, further comprising:
iterative execution of the heuristic with the interface.

3. The computer-implemented method of claim 1, wherein the user provides a plurality of objectives.

4. The computer-implemented method of claim 1, wherein each of the one or more objectives is distinct from the single objective.

5. The computer-implemented method of claim 1, comprising:
receiving, by a processor, the one or more objectives and the associated weights, identifying, by the processor, one or more criteria for each objective;
combining, by the processor, the one or more criteria into the single criterion based on the associated weights;
identifying, by the processor, one or more solution choices; and
selecting, by the processor, an optimal solution choice based on the single criterion.

6. The computer-implemented method of claim 5, further comprising:
evaluating, by the processor, the optimal solution choice against the one or more objectives and the associated weights; and
outputting, via an output user interface, the optimal solution choice to the user.

7. A system comprising:
a heuristic designed for optimization based on a single objective;
an interface in communication with the heuristic;
a processor; and
a memory storing instructions that, when executed by the processor, configure the system to:
convert one or more objectives provided to the interface into a single criterion based on associated weights of each of the one or more objectives; and
execute the heuristic based on the single criterion.

8. The system of claim 7 further configured to:
iteratively execute the heuristic with the interface.

9. The system of claim 7, wherein the interface is provided with a plurality of objectives.

10. The system of claim 7, wherein each of the one or more objectives is distinct from the single objective.

11. The system of claim 7, further configured to:
receive, by the processor, the one or more objectives and the associated weights, identify, by the processor, one or more criteria for each objective;
combine, by the processor, the one or more criteria into the single criterion based on the associated weights;
identify, by the processor, one or more solution choices; and
select, by the processor, an optimal solution choice based on the single criterion.

12. The system of claim 11, further configured to:
evaluate, by the processor, the optimal solution choice against the one or more objectives and the associated weights; and
output, via an output user interface, the optimal solution choice to the user.

13. A non-transitory computer-readable storage medium, the computer-readable storage medium including instructions that when executed by a computer, cause the computer to:
convert one or more objectives provided to an interface into a single criterion, based on associated weights of each of the one or more objectives; and
execute a heuristic in communication with the interface, based on the single criterion, the heuristic designed for optimization based on a single objective.

14. The non-transitory computer-readable storage medium of claim 13, wherein the computer is further configured to:
iteratively execute the heuristic with the interface.

15. The non-transitory computer-readable storage medium of claim 13, wherein the interface is provided with a plurality of objectives.

16. The non-transitory computer-readable storage medium of claim 13, wherein each of the one or more objectives is distinct from the single objective.

17. The non-transitory computer-readable storage medium of claim 13, wherein the computer is configured to:
receive, by a processor, the one or more objectives and the associated weights, identify, by the processor, one or more criteria for each objective;
combine, by the processor, the one or more criteria into the single criterion based on the associated weights;
identify, by the processor, one or more solution choices; and
select, by the processor, an optimal solution choice based on the single criterion.

18. The non-transitory computer-readable storage medium of claim 17, further configured to:
evaluate, by the processor, the optimal solution choice against the one or more objectives and the associated weights; and
output, via an output user interface, the optimal solution choice to the user.
